(19) United States
(12) Patent Application Publication
(10) Pub. No.: US 2004/0004994 A1
(43) Pub. Date: Jan. 8, 2004

(54) Temperature sensing read-out system for an integrated circuit

(76) Inventors: Dolly Wu, North Andover, MA (US); Paul Ferguson JR., North Andover, MA (US)

Correspondence Address: Iandiorio & Teska, 260 Bear Hill Road, Waltham, MA, 02451-1018, US

(21) Appl. No.: 10/189,961

(22) Filed: Jul. 3, 2002

(51) Int. Cl. G01K 7/00

(52) U.S. Cl. 374/170

(57) ABSTRACT

A temperature sensing read-out system for an integrated circuit includes a temperature sensor circuit for providing an analog signal representative of temperature and a high order sigma delta analog to digital converter responsive at its input to the analog signal representative of temperature to provide at its output a digital signal representative of temperature; the temperature sensing read-out system may be reconfigurable and include in addition to the temperature channel and auxiliary channel accompanied by a switching circuit for interconnecting in a temperature mode the temperature channel to the high order sigma delta analog to digital converter, and for interconnecting in one or more auxiliary modes the one or more auxiliary channels to the same sigma delta analog to digital converter.

### FIELD OF THE INVENTION

This invention relates to a temperature sensing read-out system for an integrated circuit and to such a system which is reconfigurable to serve a number of input channels.

### BACKGROUND OF THE INVENTION

Temperature sensing is an essential feature of many applications of integrated circuits in order to ensure good performance over all conditions. In communications, cell phone handsets, and wireless PDA's must be able to operate over a wide range of temperatures from −40° C. to 125° C. The crystal based oscillator on which handsets set the system clock and transmit and receive frequencies and time slots must be locked to very precise frequencies or the connection will be lost. Yet these crystals are very sensitive to even small changes in temperature. One solution is to use crystals that incorporate their own temperature sensing and compensation but these drive up the cost of the handset in a very price competitive market. A less expensive approach is to monitor the crystal temperature on the communications integrated circuit but this requires very high resolution with excellent differential nonlinearity in order to monitor the very small temperature changes that can effect the crystal. Further, this must typically be done on the system integrated circuits which are a noisy and hostile environment. Neighboring circuits are numerous and varied making for a mismatched environment. In one prior art approach, U.S. Pat. No. 5,982,221, SWITCHED CURRENT TEMPERATURE SENSOR CIRCUIT WITH COMPOUNDED ΔV_{BE}, Michael G. Tuthill, issued Nov. 9, 1999, which used a switched capacitor sample/hold with a successive approximation analog to digital converter (SAR ADC), required very good matching necessitating very large devices and much costly die space. See also “Switched Current Switched Capacitor Temperature Sensor In 0.6 μm CMOS”, Michael G. Tuthill, JSSC, Vol. 33, No. 7, July 1998. And for high resolutions SAR's the differential linearity is not inherently guaranteed. It also requires very large off-chip extra components such as anti-alias filters, entailing more space and cost. In another approach, MICROPOWER CMOS TEMPERATURE SENSOR WITH DIGITAL OUTPUT, Anton Bakker and Johan H. Huisjing, Senior Member IEEE, IEEE Journal of Solid-State Circuits, Vol. 31, No. 7, July 1996, the use of low order ADC's does not deliver enough signal to noise ratio performance in an acceptably short time interval for communications IC's. And it still requires large components and die area to achieve even the low signal to noise ratio.

### BRIEF SUMMARY OF THE INVENTION

It is therefore an object of this invention to provide an improved temperature sensing readout system for an integrated circuit.

It is a further object of this invention to provide such a temperature sensing read-out system for an integrated circuit which is faster and yet provides higher resolution, and less die space.

It is a further object of this invention to provide such a temperature sensing read-out system for an integrated circuit which is reconfigurable to serve demanding communication applications in addition to temperature sensing, thus saving much dies space.

It is a further object of this invention to provide such a temperature sensing read-out system for an integrated circuit which exhibits excellent differential non-linearity to detect even very small temperature changes and is less sensitive to mismatches.

This invention features a temperature sensing read-out system for an integrated circuit including a temperature sensor circuit for providing an analog signal representative of temperature and a high order sigma delta analog to digital converter responsive at its input to the analog signal representative of temperature to provide at its output a digital signal representative of temperature.

In a preferred embodiment the high order (order>2) sigma delta analog to digital converter may have an order of two or more and may include a high order sigma delta modulator and a digital signal processing circuit connected to the output of the high order sigma delta modulator. The digital signal processing circuit may include a decimation filter; it may include a low pass filter. The sensor may include at least one temperature sensing unit; it may include a plurality of temperature sensing units. The temperature sensor circuit may include a switching circuit for selectively connecting to the temperature sensing units. A temperature sensing unit may include a thermistor; it may include a pn junction such as a diode, or PNP or NPN device. At least one of the temperature sensor units may be on the integrated circuit; at least one of the temperature sensor units may be remote from the integrated circuit. The sensor circuit may include an optional gain switching and/or offset circuit for adjusting and/or offsetting the range of input to the high order sigma delta analog to digital converter. The high order sigma delta analog to digital modulator may include at least three stages of integrators interconnected with a quantizer and a digital to analog converter interconnected between the quantizer output and the input of the first stage integrator. The high order sigma delta analog to digital modulator may include a cascade of lower order modulator stages.

The invention also features a reconfigurable temperature sensing system including a temperature channel having a temperature sensor circuit for providing an analog signal representative of temperature; an auxiliary channel; and a high order sigma delta analog to digital converter. There may be a switching circuit for interconnecting in temperature mode the temperature channel to the high order sigma delta analog to digital converter which is responsive to the analog signal representative of temperature to provide a digital signal representative of temperature and for interconnecting in auxiliary mode the auxiliary channel to the high order sigma delta analog to digital converter.

In a preferred embodiment, the switching circuit may include a first multiplexor for selectively interconnecting the channels to the input of the high order sigma delta analog to digital converter. The auxiliary channel may be a communications channel. The high order sigma delta analog to digital converter may include a high order sigma delta modulator and a digital signal processing circuit (DSP) which may be a digital filter may be connected to the output of the high order sigma delta modulator. The high order sigma delta analog to digital converter may include a decimation filter; it may include a low pass digital filter. The temperature sensor circuit may include at least one temperature sensing unit; it may include a plurality of temperature sensing units. The temperature sensor circuit may include a switching circuit for selectively connecting to the temperature sensing units. A temperature sensing unit may include a thermistor; it may include a pn junction device. The pn junction may be implemented with a diode, PNP, or NPN device. At least one of said temperature units may be on the integrated circuit; at least one of the temperature sensor units may be remote from the integrated circuit. The temperature sensor circuit may include an optional gain switching circuit and/or offset shifting for adjusting the range of the input to the high order sigma delta analog to digital converter. The high order sigma delta analog to digital modulator may include at least three stages of integrators interconnected with a quantizer and a digital to analog converter interconnected between the quantizer output and the input of the first stage integrator. The high order sigma delta analog to digital modulator may include a cascade of lower order modulator stages.

### BRIEF DESCRIPTION OF THE DRAWINGS

Other objects, features and advantages will occur to those skilled in the art from the following description of a preferred embodiment and the accompanying drawings, in which:

FIG. 1 is a schematic block diagram of a temperature sensing read-out system for an integrated circuit according to this invention;

FIG. 2 is a view similar to FIG. 1 with a more detailed view of the temperature sensor circuit;

FIG. 3 is view similar to FIG. 1 with a more detailed view of the high order sigma delta modulator;

FIGS. 4-11 are schematic diagrams of alternative sensor units that may be used in the temperature sensor circuit of FIG. 2;

FIG. 12 is a schematic diagram of an alternative cascade of lower order modulator stages implementation of the high order sigma delta modulator of FIG. 1;

FIG. 13 is a schematic block diagram of a reconfigurable temperature sensing read-out system for an integrated circuit according to this invention; and

FIG. 14 is a more detailed view of one embodiment of the digital signal processing circuit of FIG. 13.

### PREFERRED EMBODIMENT

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings.

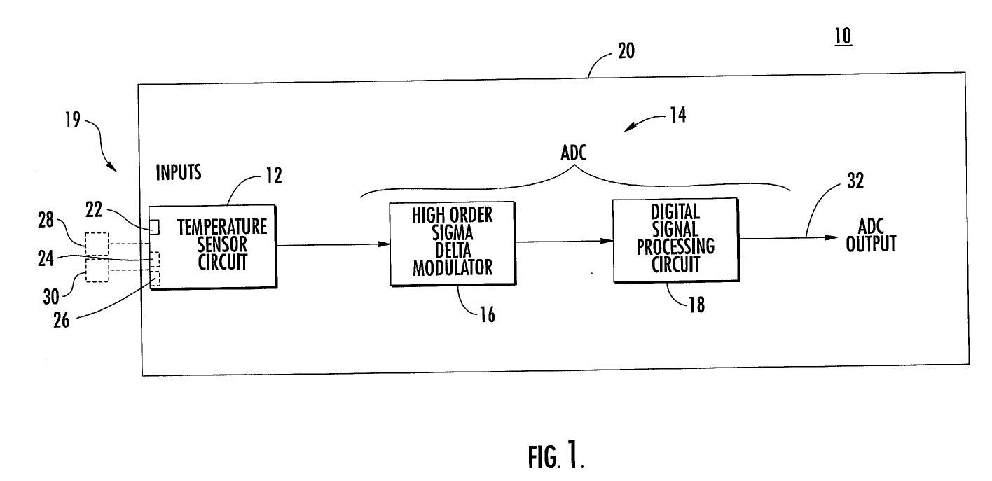

There is shown in FIG. 1 a temperature sensing read-out system 10 for an integrated circuit including a temperature sensing circuit 12 and a high order analog to digital converter 14 which includes high order sigma delta modulator 16 and digital signal processing circuit 18. By high order is meant order three or greater. The entire system is located on integrated circuit chip 20 with the exception of the sensor units 19 that form a part of the temperature sensor circuit 12 which may either be on the integrated circuit, temperature sensor units 22, 24, and 26, or remote from the integrated circuit as exemplified by temperature sensor units 28 and 30. Temperature sensor unit 12 may include one or many such units which may be all on the integrated circuit, all remote from the integrated circuit or some may be on the integrated and some remote. The temperature is sensed by one or more of the temperature sensor units 22-30 in temperature sensor circuit 12 then processed through analog to digital converter 14 through high order sigma delta modulator 16 and digital signal processing circuit 18 to provide a digital output 32 to control and compensating circuits not here shown. Filter 18 may be a decimation filter, a low pass filter or other suitable filter.

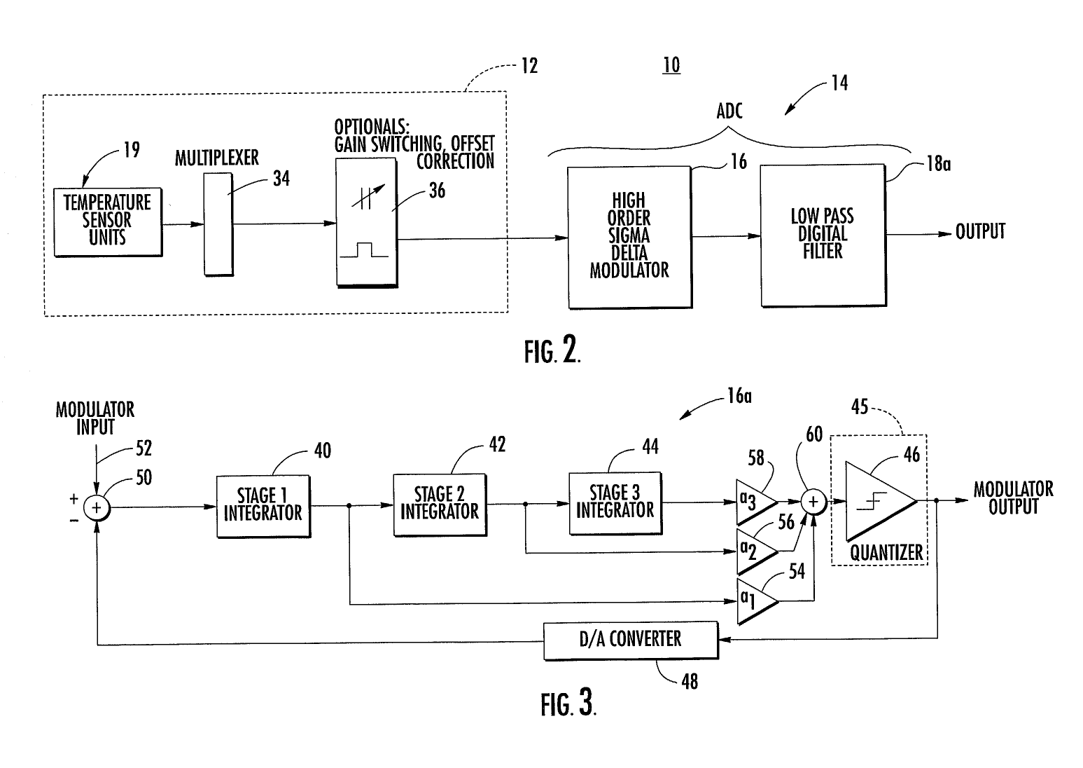

Digital signal processing circuit 18 may include a low pass digital filter 18a, FIG. 2, and temperature sensor circuit 12 may include in addition to the temperature sensor units 19, a multiplexor 34 for selecting the inputs from one or more of the individual temperature sensor units, and an optional gain/offset switching circuit 36 for adjusting the range and shifting the offset of the input to the high order sigma delta modulator 16. The use of the high order sigma delta modulator 16 in the high order sigma delta analog to digital converter 14 provides for the first time a fast, yet high resolution, power efficient, solution in a hostile environment using less die space and with excellent differential non-linearity so that it can detect even very small changes which would affect things like the frequency of the crystals determining the system time periods in a handset or a cell phone and it does so to such a degree that it can even be used in a reconfigurable arrangement to serve other demanding applications such as communication applications in addition to the temperature sensing application thus saving much die space.

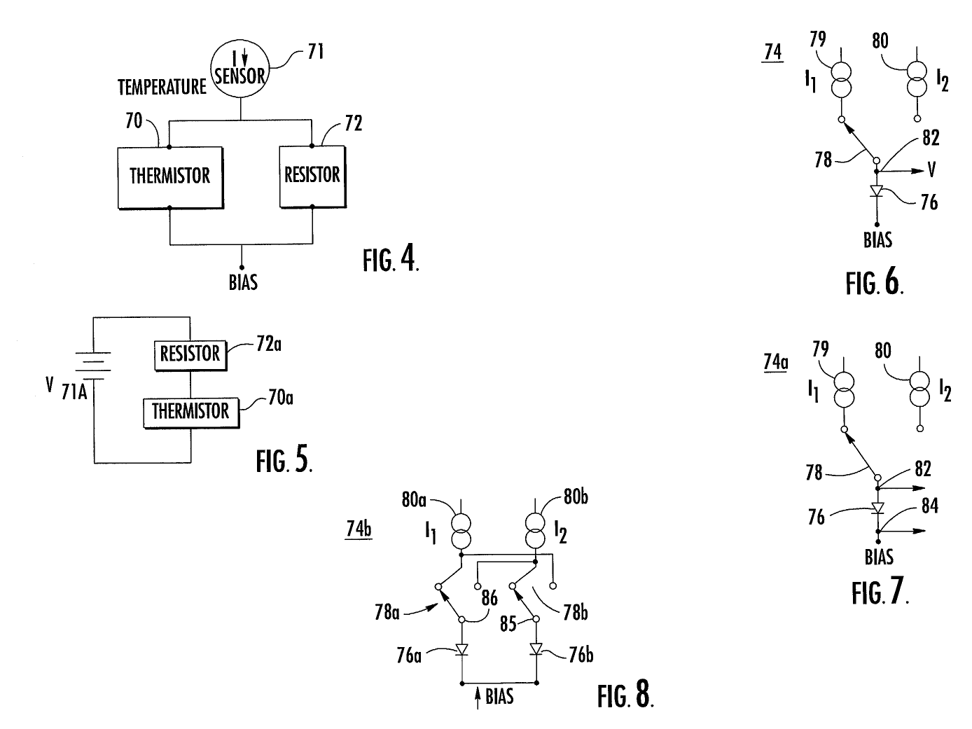

High order sigma delta modulator 16 is shown in one embodiment 16a, FIG. 3 as including a plurality of modulator stages, in this case, for simplicity, three: integrators 40, 42, and 44 connected in series to analog to digital converter 45 which may include quantizer 46 whose output is connected to digital to analog converter 48 and then back to the input of stage one integrator 40 through summing circuit 50 where it is summed with the modulator input on line 52. Each of the integrators, stage one integrator 40, stage two integrator 42, and stage three integrator 44 have their outputs delivered to a scale factor element 54, 56, and 58, respectively, whose outputs are combined in summer 60 before delivery to quantizer 46, as will be understood by those skilled in the art.

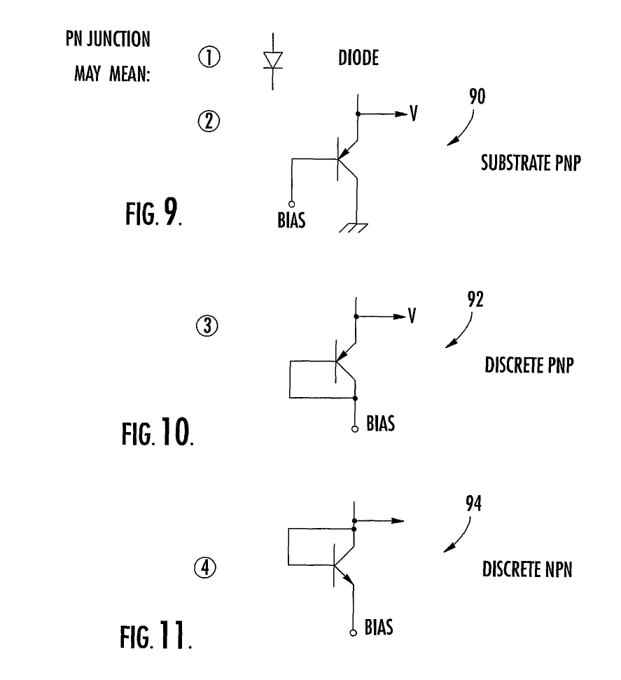

The temperature sensor units 19 may be implemented by passing a current on line 71 through a thermistor 70 in parallel with a resistor 72, FIG. 4, or placing a voltage, V, battery between 71a, across a thermistor 70a in series with resistor 72a, FIG. 5. The temperature sensor units 19 may also include a single element device 74 measured at a single node, FIG. 6 which includes a PN junction diode 76 in series with a switch 78 and current sources 79 and 80. A clock signal periodically closes switch 78 so that two different currents pass through diode 76, generating two sequential voltages sensed at node 82 and used to interpret any variations in temperature. Alternatively, a temperature sensor unit 19 may be implemented using a single element device, 74a, FIG. 7, measured at dual nodes, where upon the periodic closing of switch 78, the voltage is taken at node 82 and 84 across diode 76 to be used to evaluate changes in temperature. Further, a pair of diodes 76a, 76b, FIG. 8 may be separately simultaneously pulsed with current from current generators 80a and 80b by the closing of switches 78a and 78b, simultaneously, to provide a differential voltage across nodes 86 and 88 which can be used to evaluate variations in temperature. The PN junction sensors are not limited to diodes, but may be implemented by any kind of PN device, such as substrate PNPs 90, FIG. 9, discrete PNPs 92, FIG. 10, or discrete NPNs 94, FIG. 11, for example, or numerous other temperature sensing devices. The temperature sensing units may be all of the same type or of different types in accordance with the invention.

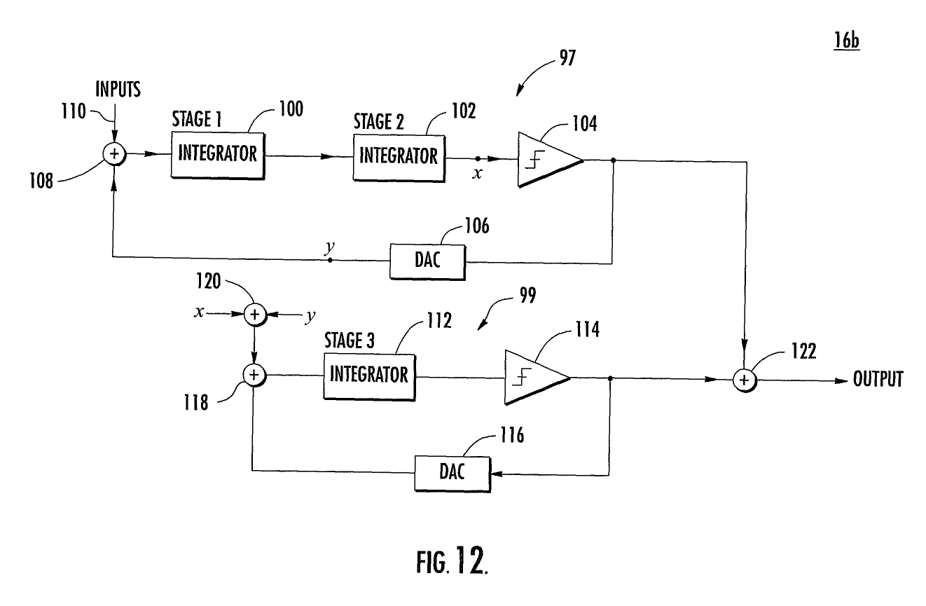

While high order sigma delta analog to digital converter 14 is shown including high order sigma delta modulator 16, FIG. 1 including a plurality of integrators, namely three or more integrators, integrators 40, 42, and 44 in FIG. 3, this is not a necessary limitation of the invention as other constructions of high order sigma delta modulator are also applicable. For example, high order sigma delta modulator 16b, FIG. 12, may include a cascade of lower order modulator stages including two sections 97 and 99. Section 97 may include a stage one integrator 100, a stage two integrator 102 connected to comparator 104. The output of comparator 104 is connected through digital to analog converter 106 to summing circuit 108 where it is combined with inputs on line 110 and delivered to stage one integrator 100. Section 99 includes stage one integrator 112 connected to comparator 114 whose output is fed back through digital to analog converter 116 to summing circuit 118 where it is combined with the summation of x and y inputs from summer 120. The x input is the signal between integrator 102 and comparator 104. The y input is the output of digital to analog converter 106. The outputs of comparator 104 and 114 are combined in summing circuit 122 to provide the ultimate output.

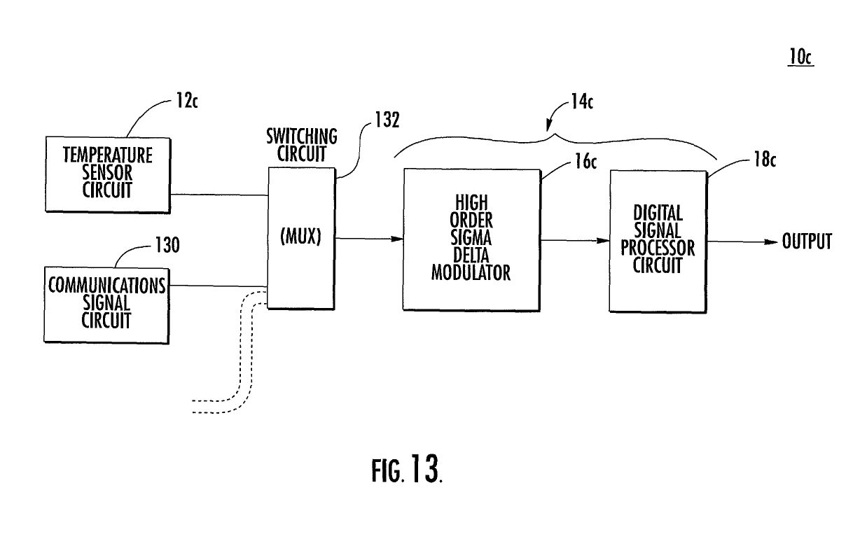

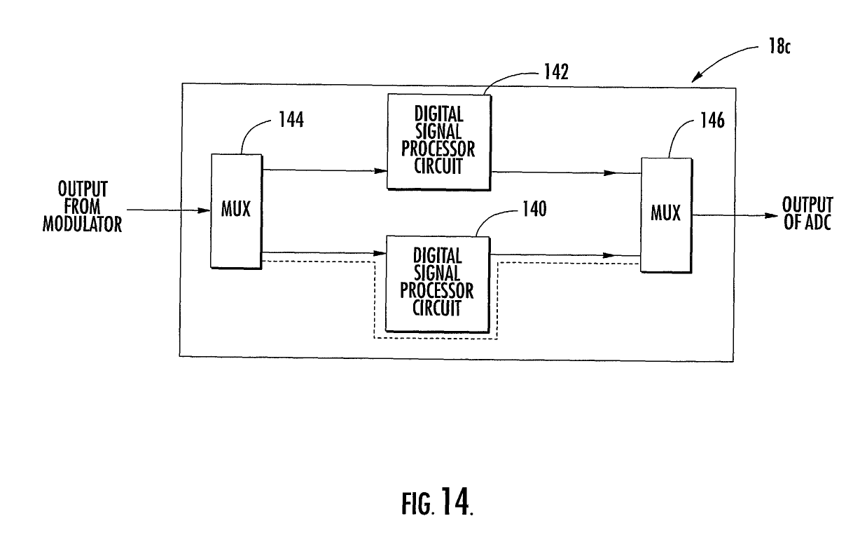

The high quality performance of high order sigma delta modulator in the high order sigma delta analog to digital converter in accordance with this invention enables it to be used for other applications in addition to the temperature sensing, especially those applications whose demands were traditionally too much for components of conventional temperature sensing circuits such as those used in the prior art. Thus, to further save on die space and cost the temperature sensing read-out system of this invention 10c may be made reconfigurable by interconnecting it not just with temperature sensor circuit 12c but with one or more other circuits such as communications signal circuit 130, FIG. 13, and providing a switching circuit such as mux 132 which can selectively interconnect either temperature sensor circuit 12c or communications signal circuit 130 with high order sigma delta modulator 16c. In such a dual or multipurpose application digital signal processing circuit 18c, FIG. 13, may be implemented using one or more different digital signal processor circuits 140 and 142, FIG. 14, in combination with switching circuits, mux's 144 and 146 so that depending upon which of the input channels temperature, communications or other auxiliary is selected, mux 144 can connect the output of modulator 16c to the desired one of circuits 140 and 142 and the active filter output can then be delivered by mux 146 as the output of the analog to digital converter.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims:

What is claimed is:

1. A temperature sensing read-out system for an integrated circuit comprising:
a temperature sensor circuit for providing an analog signal representative of temperature; and
a high order sigma delta analog to digital converter responsive at its input to said analog signal representative of temperature to provide at its output a digital signal representative of temperature.

2. The temperature sensing read-out system of claim 1 in which said high order sigma delta analog to digital converter has an order of three or greater.

3. The temperature sensing read-out system of claim 1 in which said high order sigma delta analog to digital converter includes a high order sigma delta modulator and a digital signal processing circuit connected to the output of said high order sigma delta modulator.

4. The temperature sensing read-out system of claim 3 in which said digital signal processing circuit includes a digital filter.

5. The temperature sensing read-out system of claim 3 in which said high order sigma delta analog to digital converter includes a decimation filter.

6. The temperature sensing read-out system of claim 3 in which said high order sigma delta analog to digital converter includes a low pass digital filter.

7. The temperature sensing read-out system of claim 1 in which said temperature sensor circuit includes at least one temperature sensing unit.

8. The temperature sensing read-out system of claim 1 in which said temperature sensor circuit includes a plurality of temperature sensing units.

9. The temperature sensing read-out system of claim 8 in which said temperature sensor circuit includes a switching circuit for selectively connecting to said temperature sensing units.

10. The temperature sensing read-out system of claim 7 in which a said temperature sensing unit includes a thermistor.

11. The temperature sensing read-out system of claim 7 in which a said temperature sensing unit includes a pn junction device.

12. The temperature sensing read-out system of claim 1 in which at least one of said temperature sensor units is on the integrated circuit.

13. The temperature sensing read-out system of claim 1 in which at least one of said temperature sensor units is remote from the integrated circuit.

14. The temperature sensing read-out system of claim 1 in which said temperature sensor circuit includes an optional gain/offset switching circuit for adjusting the range of the input to said high order sigma delta analog to digital converter.

15. The temperature sensing read-out system of claim 1 in which said high order sigma delta analog to digital modulator includes at least three stages of integrators interconnected with a quantizer and a digital to analog converter interconnected between the quantizer output and the input of the first stage integrator.

16. The temperature sensing read-out system of claim 1 in which said high order sigma delta modulator includes a cascade of lower order modulator stages.

17. A reconfigurable temperature sensing system comprising:
a temperature channel including a temperature sensor circuit for providing an analog signal representative of temperature;
an auxiliary channel;
a high order sigma delta analog to digital converter; and
a switching circuit for interconnecting in temperature mode said temperature channel to said high order sigma delta analog to digital converter which is responsive to said analog signal representative of temperature to provide a digital signal representative of temperature, and for interconnecting in auxiliary mode said auxiliary channel to said high order sigma delta analog to digital converter.

18. The reconfigurable temperature sensing system of claim 17 in which said switching circuit includes a first multiplexor for selectively interconnecting said channels to the input of said high order sigma delta analog to digital converter.

19. The reconfigurable temperature sensing system of claim 17 in which said auxiliary channel is a communications channel.

20. The reconfigurable temperature sensing system of claim 17 in which said high order sigma delta analog to digital converter includes a high order sigma delta modulator and a digital signal processing circuit connected to the output of said high order sigma delta modulator.

21. The reconfigurable temperature sensing system of claim 20 in which said digital signal processing circuit includes a filter.

22. The reconfigurable temperature sensing system of claim 20 in which said high order sigma delta analog to digital converter includes a decimation filter.

23. The reconfigurable temperature sensing system of claim 19 in which said high order sigma delta analog to digital converter includes a low pass digital filter.

24. The reconfigurable temperature sensing system of claim 17 in which said temperature sensor circuit includes at least one temperature sensing unit.

25. The reconfigurable temperature sensing system of claim 17 in which said temperature sensor circuit includes a plurality of temperature sensing units.

26. The reconfigurable temperature sensing system of claim 25 in which said temperature sensor circuit includes a switching circuit for selectively connecting to said temperature sensing units.

27. The reconfigurable temperature sensing system of claim 24 in which a said temperature sensing unit includes a thermistor.

28. The reconfigurable temperature sensing system of claim 24 in which a said temperature sensing unit includes a pn junction device.

29. The reconfigurable temperature sensing system of claim 17 in which at least one said temperature sensor unit is on the integrated circuit.

30. The reconfigurable temperature sensing system of claim 17 in which at least one said temperature sensor units is remote from the integrated circuit.

31. The reconfigurable temperature sensing system of claim 17 in which said temperature sensor circuit includes an optional gain/offset switching circuit for adjusting the range of the input to said high order sigma delta analog to digital converter.

32. The reconfigurable temperature sensing system of claim 17 in which said high order sigma delta analog to digital modulator includes at least three stages of integrators interconnected with a quantizer and a digital to analog converter interconnected between the quantizer output and the input of the first stage integrator.

33. The reconfigurable temperature sensing system of claim 17 in which said high order sigma delta modulator includes a cascade of lower order modulator stages.
